(19) United States
(12) Patent Application Publication
(10) Pub. No.: US 2006/0215207 A1
(43) Pub. Date: Sep. 28, 2006

(54) Color and monochrome management printing system

(75) Inventor: Zhongming Shen, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 11/090,062

(22) Filed: Mar. 28, 2005

(51) Int. Cl. G06K 15/00

(52) U.S. Cl. 358/1.14

(57) ABSTRACT

The present application relates to a printing system, comprising a color printer, which can distinguish an authorized user who can make color prints and an unauthorized user who can make only monochrome prints, but not color printers.

### FIELD

The present invention relates to a system which can print in both of color and monochrome.

Introduction

By utilizing a printing system including a printer and a personal computer (PC), an user can print documents which the users produce by his/her PC. If the user uses a color printer, the user can make a color print easily.

However, utilizing such color printing system exhibits certain drawback. The color print still remains relative high in terms of cost per print. Therefore, it would be ideal in an office to allow most of users to print monochrome only, but allow some privileged users to print color documents. However, if different kind of software is prepared for the monochrome users and the color users respectively to divide the users into the monochrome users and the color users, it makes the printing system complicated and the monochrome user can print color easily only by installing the software for the color users.

Therefore, it is desirable that the printing system can distinguish the monochrome users and the color users easily without using several different kind of software for the color users and the monochrome users respectively in one printing system.

### SUMMARY

According to various embodiments, the present teachings can provide a color and monochrome management printing system. The color and monochrome management printing system can comprise a storing section that stores reference information. The color and monochrome management printing system can comprise an input section that inputs user information. The color and monochrome management printing system can comprise an authorizing section that compares the user information input by the input section with the reference information stored in the storing section. The color and monochrome management printing system can comprise a print section that makes a color print and a monochrome print. If the authorizing section judges that the user information is the information of the authorized user as a result of comparing the user information with the reference information, the authorizing section can allow the print section to make both of the color print and the monochrome print. If the authorizing section judges that the user information is the information of the unauthorized user as a result of comparing the user information with the reference information, the authorizing section can allow the print section to make only the monochrome print, but not the color print.

### BRIEF DESCRIPTION OF THE DRAWINGS

FIG. 1 illustrates a figure of relationship among application software, printer driver and print spooler, according to certain embodiments.

FIG. 2 illustrates a block diagram of a printing system comprising a PC and a printer, according to certain embodiments.

FIG. 3 illustrates a flowchart describing the inputting of the reference information, according to certain embodiments.

FIG. 4 illustrates a flowchart describing the managing the color prints and the monochrome prints, according to certain embodiments.

FIG. 5 illustrates a flowchart describing the inputting of the reference information, according to certain embodiments.

FIG. 6 illustrates a flowchart describing the managing the color prints and the monochrome prints, according to certain embodiments.

### DESCRIPTION OF CERTAIN EMBODIMENTS

System and Apparatus

In certain embodiments, a color and monochrome management printing system can comprise one or several PC(s) and/or server(s). In certain embodiments, the color and monochrome management printing system can comprise one or several color printer(s). In certain embodiments, the color and monochrome management printing system can comprise one or several monochrome printer(s) in addition to the color printer. In certain embodiments, the color and monochrome management printing system can comprise network which connects the PC and/or the server with the color printer.

In certain embodiments, the color and monochrome management printing system can comprise one or several user computer(s) for normal users. In certain embodiments, the PC can be the user computer. In certain embodiments, the color and monochrome management printing system can comprise one or several management computer(s) for special people such as computer system management people. In certain embodiments, the PC can be the management computer.

In certain embodiments, the management computer can restrict the users who can use the management computer. In certain embodiments, the management computer can restrict the users by detecting information of the user (e.g., password. ID number, the user's name and the like) input to the management computer by the user and allowing the user to use the computer only if the information input is consistent with the information stored in the management computer or the other computer connected with the management computer beforehand. For instance, the management computer can be set up so that only computer system management people can use the management computer.

In certain embodiments, the user computer also can restrict the users who can use the user computer. In certain embodiments, the user computer can restrict the users by the same way as the management computer as the above. On the other hand, the user computer might not restrict the users who can use the user computer.

In certain embodiments, the user computer and the management computer can comprise at least one of a hard disk, a memory, a data transfer section, a display section, an input section and a central processing unit (CPU) or a micro processing unit (MPU). Examples of the data transfer section consistent with certain embodiments of the invention include, but are not limited to, a local area network (LAN) adapter, a modem and a network card. Examples of the display section consistent with certain embodiments of the invention include, but are not limited to, a liquid crystal display (LCD), a Braun tube, a cathode ray tube (CRT) and a plasma display panel. Examples of the input section consistent with certain embodiments of the invention include, but are not limited to, a keyboard, a mouse, a push button and a touch panel.

In certain embodiments, application software can be installed into the user computer and/or the management computer in addition to operating system (OS). In certain embodiments, the application software can be used to produce color document data (including document, drawing, table, picture and/or photo and the like) which can be printed by the color printer. Examples of the application software consistent with certain embodiments of the invention include, but are not limited to, word processor software (e.g., Microsoft Word™ etc.), image processing software (e.g., Adobe Photoshop™ etc.), spread sheet software (e.g., Microsoft Excel™ etc) and viewer software (e.g., Acrobat Reader™ etc.).

In certain embodiments, software of printer driver for the color printer can be installed into the user computer. In certain embodiments, the printer driver can control the color printer connected with the user computer in which the printer driver is installed. In certain embodiments, the printer driver can produce a print job based on the color document data produced by the application software of the user computer or another PC. In certain embodiments, the printer driver can control transfer of the print job from the user computer to the color printer.

In certain embodiments, software of print spooler can be installed into the user computer. In certain embodiments, the print spooler can conduct management process of printing, that is a spooler process. Such spooler process can involve retrieving location of correct printer driver, loading that printer driver, spooling high-level function calls into the print job, scheduling print job for printing, and so on. In certain embodiments, the software of the print spooler can start at system starting time and is available until either service is stopped or OS shutdown. In certain embodiments, the application software and/or the printer driver can conduct the spooler process with the print spooler.

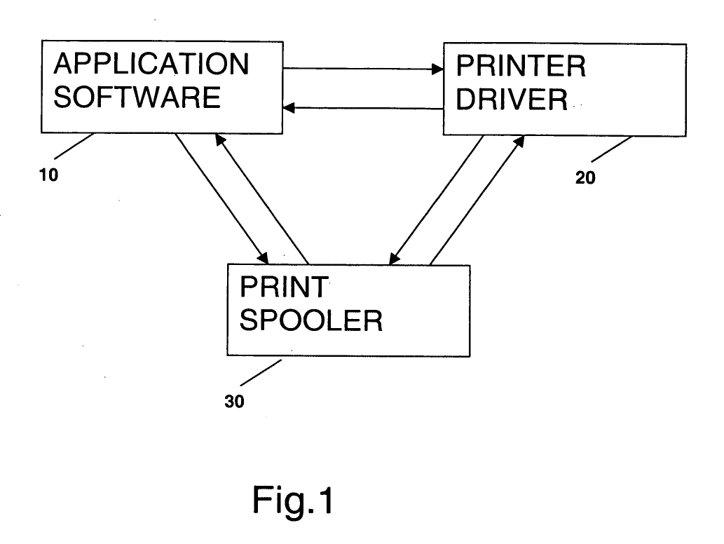

In certain embodiments, as illustrated in FIG. 1, relationship among the application software, the printer driver and the print spooler can be shown. In certain embodiments, application software 10 can produce the color document data and send the color document data to the printer driver 20. In certain embodiments, the printer driver 20 can produce the print job and send the print job to the print spooler 30. In certain embodiments. the printer driver 20 can provide printer condition to the application software 10. In certain embodiments, the print spooler 30 can store the print job sent from the printer driver. In certain embodiments, the print spooler 30 can send the print job to the printer driver 20 to send the print job from the user computer to the color printer. In certain embodiments, the communication between the application software 10 and the print spooler 30 can deal with general job information (e.g., printer condition, print job status, port selection and the like).

Examples of the color printer consistent with certain embodiments of the invention include, but are not limited to, a laser beam color printer, a multi function color printer including copying function (MFP), an ink jet printer, a thermal printer (e.g., dye sublimation printers) and a silver halide printer. In certain embodiments, the printer can comprise at least one of a print section, a CPU or a MPU, a memory, a display section, an input portion and a data transfer section. Examples of the data transfer section, the display section and the input section consistent with certain embodiments of the invention include, but not limited to, examples described in the above.

Examples of the network consistent with certain embodiments of the invention include, but are not limited to, an internet, a LAN and a wide area network (WAN). The color printer, the user computer and the management computer can be connected with a wire or be connected with wireless by using radio frequency (RF) and/or infrared (IR) transmission.

In certain embodiments, the color and monochrome management printing system can comprise at least one of a storing section, an input section, an authorizing section and a print section.

In certain embodiments, the color and monochrome management printing system can comprise a reference information input section. In certain embodiments, reference information can be input to the color and monochrome management printing system by the reference information input section. In certain embodiments, only limited people (e.g., computer system management people and the like) can input the reference information by the reference information input section. Examples of the reference information input section consistent with certain embodiments of the invention include, but are not limited to, a keyboard, a mouse, a push button and a touch panel. In certain embodiments, the reference information input by the reference information input section can be stored in the storing section. In certain embodiments, the reference information input section can amend the reference information stored in the storing section. In certain embodiments, the management computer can comprise the reference information input section. In certain embodiments, only the management computer can comprise the reference information input section and any other computer including the user computer of the color and monochrome management printing system might not comprise the reference information input section.

In certain embodiments, the reference information can be information to be utilized when it is judged whether both of the color print and monochrome print can be allowed to the user and/or the user computer, or only the monochrome print can be allowed to the user and/or the user computer. In certain embodiments, the reference information can comprise authorized information and unauthorized information. In certain embodiments, the authorized information can be information of authorized user who can be allowed to make both of the color print and the monochrome print or information of authorized user computer which can be allowed to make both of the color print and the monochrome print. For instance, the authorized information can comprise at least one of name of the authorized user, ID number of the authorized user, keyword of the authorized user, name of the user computer, ID number of the user computer (e.g., IP address, Ethernet MAC address, Disk ID, USB ID and the like), a name of the user computer, a keyword of the user computer and the like. In certain embodiments, the unauthorized information can be information of unauthorized user who can be allowed to make only monochrome print. For instance, the unauthorized information can comprise at least one of name of the unauthorized user, ID number of the unauthorized user, keyword of the unauthorized user, name of the user computer, ID number of the user computer (e.g., Ethernet MAC address, Disk ID, USB ID and the like), keyword for the user computer and the like. In certain embodiments, the reference information can comprise only authorized information or only unauthorized information. For instance, one example of reference information can be displayed in the Table 1. In this example, the reference information is the information of the user computer (e.g., the name of the user computer).

TABLE 1

| | Reference Information | Color or | |
|---|---|---|---|
| User | (the name of the user | Monochrome | Type of Reference |
| Computer | computer) | Print | Information |
| PC 1 | 001 | Color and | Authorized |
| | | Monochrome | Information |
| | | Print | |
| PC 2 | 002 | Only | Unauthorized |
| | | Monochrome | Information |
| | | Print | |

Another example of reference information can be displayed in the Table 2. In this example, the reference information is the information of the user (e.g., the user ID and the keyword of the user).

TABLE 2

| | Reference Information | Color or | |
|---|---|---|---|
| | (the user ID and the | Monochrome | Type pf Reference |
| User | keyword of the user) | Print | Information |
| User A | ID number: 12345 | Color and | Authorized |
| | Keyword: XAFRDT | Monochrome | Information |
| | | Print | |
| User B | ID number: 12346 | Only | Unauthorized |
| | Keyword: FRHARK | Monochrome | Information |
| | | Print | |

In certain embodiments, the reference information of the same user or the same user computer can be established for each color printer respectively. For instance, the user A can make both of the color print and the monochrome print by the color printer X, and can make only the monochrome print by the color printer Y. In other words, the authorized information of the user A is for the printer X and the unauthorized information of the user A is for the printer Y.

In certain embodiments, the color and monochrome management printing system can comprise the storing section. In certain embodiments, the storing section can store the reference information. In certain embodiments, the storing section can store the reference information input by the reference information input section. In certain embodiments, the storing section can store both of the authorized information and the unauthorized information. In certain embodiments, the storing section can store only the authorized information. In certain embodiments, the storing section only the unauthorized information. Examples of the data storing portion consistent with certain embodiments of the invention include, but are not limited to, a hard disk and a memory (e.g., a random access memory(RAM) including NVRAM, M RAM, P RAM, Fe RAM, Flash RAM, and a read only memory(ROM)). In certain embodiments, the color printer can comprise the storing section. In certain embodiments, the user computer can comprise the storing section. In certain embodiments, if the color and monochrome management print system comprises several user computers or several color printers, each user computer or each color printer can comprise the storing section respectively.

In certain embodiments, the color and monochrome management printing system can comprise the input section. In certain embodiments, user information can be input by the input section. In certain embodiments, various data, instruction, operation to the color and monochrome management print system and the like can be input by the input section. Examples of the input section consistent with certain embodiments of the invention include, but are not limited to, a keyboard, a mouse, a push button, a touch panel. In certain embodiments, the input section can detect the identification information of the user computer as the user information automatically. In certain embodiments, the input section can comprise software for detecting the identification information of the user computer (e.g., application program interface (API) and the like) and can detect the identification information of the user computer as the user information by the software. In this case, the CPU, the memory and the hard disk can be the input section. In certain embodiments, the user computer can comprise the input section.

In certain embodiments, the user information can be the information to identify the user who uses the color printer or the user computer which sends the print job to the color printer. For instance, the user information can be name of the user, the ID number of the user, the keyword of the user, the name of the user computer, the ID number (e.g., Ethernet MAC address, Disk ID, USB ID and the like) of the user computer, the keyword for the user computer. In certain embodiments, the user information input by the input section can be sent to the authorizing section.

In certain embodiments, the color and monochrome management printing system can comprise the print section. In certain embodiments, the print section can make both of the color prints and the monochrome prints. In certain embodiments, the print section can print based on the print job produced and sent by the printer driver of the user computer. Examples of the print section consistent with certain embodiments of the invention include, but are not limited to, a print unit of the color printer and a print engine of the color printer. In certain embodiments, the color printer can comprise the print section.

In certain embodiments, the color and monochrome management printing system can comprise a display section. In certain embodiments, the display section can display several images, instruction, messages and so on. In certain embodiments, the message or the icon for print instruction can be displayed on the display section according to the printer driver. Examples of the display section consistent with certain embodiments of the invention include, but are not limited to, a liquid crystal display (LCD), a Braun tube, a cathode ray tube (CRT) and a plasma display panel. In certain embodiments, the user computer, the management computer and the color printer can comprise the display section.

In certain embodiments, the color and monochrome management printing system can comprise the authorizing section. In certain embodiments, the authorizing section can compare the user information input by the input section with the reference information stored in the storing section. In certain embodiments, if the authorizing section judges that the user information is the information of the authorized user as a result of comparing the user information with the reference information, the authorizing section can allow the print section directly or indirectly to make both of the color print and the monochrome print. In certain embodiments, if the authorizing section judges that the user information is the information of the unauthorized user as a result of comparing the user information with the reference information, the authorizing section can allow the print section directly or indirectly to make only the monochrome print, but not the color print. Examples of the authorizing section consistent with certain embodiments of the invention include, but are not limited to, a CPU or a MPU with a memory (e.g., a random access memory(RAM) including NVRAM, M RAM, P RAM, Fe RAM, Flash RAM, and a read only memory(ROM)) and necessary software for comparison, judgment, authorization and so on. In certain embodiments, it is preferable that the storing section and the authorizing section are incorporated into the same apparatus. If the user computer comprises the storing section storing the reference information, it is preferable the same user computer comprises the authorizing section. If the color printer comprises the storing section storing the reference information, it is preferable the same color printer comprises the authorizing section. In certain embodiments, if the color and monochrome management printing system comprises several user computers or several color printers, each user computer or each color printer can comprise the authorizing section respectively. In certain embodiments, if the user computer comprises the authorizing section, the software for the authorizing section can be the printer driver and the authorizing section can be the CPU or the MPU and the memory of the user computer with the printer driver. In certain embodiments, the software for the authorizing section can be the specialized software which is different with the printer driver. It is preferable that the same software can be used for each user computer or each color printer in one color and monochrome management printing system.

In certain embodiments, if the storing section stores the authorized information and the authorizing section detects that the user information input by the input section is consistent with the authorized information stored in the storing section, the authorizing section can judge that the user information is the information of the authorized user. In certain embodiments, if the storing section stores the authorized information and does not store the unauthorized information, and the authorizing section detects that the user information input by the input section is not consistent with the authorized information stored in the storing section, the authorizing section can judge that the user information is the information of the unauthorized user. In certain embodiments, if the storing section stores the unauthorized information and the authorizing section detects that the user information input by the input section is consistent with the unauthorized information stored in the storing section, the authorizing section can judge that the user information is the information of the unauthorized user. In certain embodiments, if the storing section stores both of the authorized information and the unauthorized information, and the authorizing section detects that the user information input by the input section is not consistent with any of the authorized information and the unauthorized information stored in the storing section, the authorizing section can judge that the user information is the information of the authorized user. On the contrary, if the storing section stores both of the authorized information and the unauthorized information, and the authorizing section detects that the user information input by the input section is not consistent with any of the authorized information and the unauthorized information stored in the storing section, the authorizing section can judge that the user information is the information of the unauthorized user.

For instance, the storing section (e.g., the hard disk) of the user computer or the color printer can store the reference information comprising the authorized information and the unauthorized information described in the Table 2. Then, the user A can input the user information (e.g., the ID number and the keyword) by the input section (e.g., the keyboard) of the user computer. The authorizing section (e.g., the CPU and the memory with software) of the user computer or the color printer can detect that the user information of the user A is consistent with the authorized information stored in the storing section, can judge that the user information of the user A is the information of the authorized user and can allow the user A to make both of the color prints and the monochrome prints. On the other hand, if the user B inputs the user information by the input section, the authorizing section can detect that the user information of the user B is consistent with the unauthorized information stored in the storing section, can judge that user information of the user B is the information of the unauthorized user and can allow the user B to make only monochrome prints, but not color prints. Furthermore, if the user C inputs the user information by the input section, the authorizing section can detect that the user information of the user C is not consistent with any of the authorized information and the unauthorized information, can judge that user information of the user C is the information of the unauthorized user and can allow the user C to make only monochrome prints, but not color prints.

In certain embodiments, if the authorizing section judges that the user information is the information of the authorized user, the authorizing section can allow the print section directly to make both of the color print and the monochrome print. In certain embodiments, if the authorizing section judges that the user information is the information of the authorized user, the authorizing section can allow the printer driver to allow the print section to make both of the color print and the monochrome print.

In certain embodiments, if the authorizing section judges that the user information is the information of the unauthorized user, the authorizing section can allow the print section directly to make only the monochrome print, but not the color print. In certain embodiments, if the unauthorized user instructs to make color print, the authorizing section can control the print section so that the print section does not make any print. In certain embodiments, if the unauthorized user instructs to make color print, the authorizing section can control the print section so that the print section makes monochrome prints automatically. In certain embodiments, if the authorizing section judges that the user information is the information of the unauthorized user, the authorizing section can allow the printer driver to allow the print section to make only the monochrome print, but not the color print. In certain embodiments, if the unauthorized user instructs to make color print, the printer driver can control the print section based on the instruction from the authorizing section so that the print section does not make any print. In certain embodiments, if the unauthorized user instructs to make color print, the printer driver can control the print section based on the instruction from the authorizing section so that the print section makes monochrome prints automatically. In certain embodiments, if the authorizing section judges that the user information is the information of the unauthorized user, the authorizing section can control the printer driver so that the user cannot instruct the color print by the printer driver from the user computer. In certain embodiments, the printer driver can prohibit the unauthorized user from instructing to make color prints by making an icon for a color print invalid.

In certain embodiments, the user computer can comprise the authorizing section. In certain embodiments, the color printer can comprise the authorizing section. In certain embodiments, both of the user computer and the color printer can comprise the authorizing section.

For instance, if the color printer comprises the authorizing section, the user computer can transfer the user information input by the input section to the authorizing section of the color printer and the authorizing section of the color printer can judge whether the user information is the information of the authorized user or the unauthorized user and send the result of the judgment to the user computer and the printer driver of the user computer can control according to the result sent from the authorizing section whether the user can instruct both of color prints and monochrome prints or only monochrome prints. If the color printer comprises the authorizing section, the user computer can transfer the user information input by the input section to the color printer and the authorizing section of the color printer can judge whether the user information is the information of the authorized user or the unauthorized user and can control the print section of the color printer according to the result of judgment so that the user can make both of color prints and monochrome prints or only monochrome prints. If the color printer comprises the authorizing section, the user computer can transfer the user information input by the input section to the color printer immediately after the user information is input to the user computer. If the color printer comprises the authorizing section, the user computer can transfer the user information input by the input section to the color printer immediately after the user instructs to start printing from the user computer by the input section.

If the user computer comprises the authorizing section, the authorizing section of the user computer can judge whether the user information is the information of the authorized user or the unauthorized user and the printer driver can control according to the result of the judgment whether the user can instruct both of color prints and monochrome prints or only monochrome prints. If the user computer comprises the authorizing section, the authorizing section of the user computer can judge whether the user information is the information of the authorized user or the unauthorized user and send the result of the judgment to the color printer and can control the color printer so that the user can make both of color prints and monochrome prints or only monochrome prints. If the user computer comprises the authorizing section, the authorizing section of the user computer can judge whether the user information is the information of the authorized user or the unauthorized user immediately after the user information is input to the user computer. If the user computer comprises the authorizing section, the authorizing section of the user computer can judge whether the user information is the information of the authorized user or the unauthorized user immediately after the user instructs to start printing from the user computer by the input section.

In certain embodiments, the color and monochrome management printing system can comprise a data transfer section. In certain embodiments, the data transfer section can transfer at least one of the print job, the user information and the reference information. In certain embodiments, if the user computer comprises the input section and the color printer comprises the authorizing section, the data transfer section can transfer the user information input by the input section of the user computer to the authorizing section of the color printer. For instance, the ID number of the user, which is the user information, input by the keyboard, which is the input section, of the user computer can be sent to the color printer comprising the storing section by the data transfer section. For other instance, the ID number of the user computer, which is the user information, detected by the CPU, which is the input section, of the user computer can be sent to the color printer comprising the storing section by the data transfer section. In certain embodiments, if the management computer comprises the reference information input section and the user computer or the color printer comprises the storing section, the data transfer section can transfer the reference information input by the reference information input section of the management computer to the storing section of the user computer or the color printer. In certain embodiments, the management computer, the user computer and the color printer can comprise the data transfer information. Examples of the data transfer section consistent with certain embodiments of the invention include, but are not limited to, a LAN adapter, a modem and a network card.

In certain embodiments, the software for the authorizing section can be installed in the user computer or the color printer. In certain embodiments, the software for the authorizing section can be the printer driver to be installed in the user computer. In certain embodiments, the software for the authorizing section can be the specialized software which is different with the printer driver and is installed in the user computer or the color printer. In certain embodiments, the software can be installed into conventional printing system comprising the user computer and the color printer so that the user computer comprises the authorizing section.

In certain embodiments, the software can be recorded onto a removable data recording medium. Examples of the removable data recording medium include, but are not limited to, digital memory cards, compact discs (e.g., CD-R, CD-RW, etc.), and digital versatile discs (e.g., DVD-R, DVD−RW, DVD+RW, etc.). Various types of digital memory cards compatible with certain embodiments of the invention include, but are not limited to, secure digital (SD) memory cards, Compact Flash™, Smart Media™, Memory Stick™, and the like.

In certain embodiments, the software can be delivered through the network (e.g., LAN, WAN, internet and so on).

### EXAMPLE 1

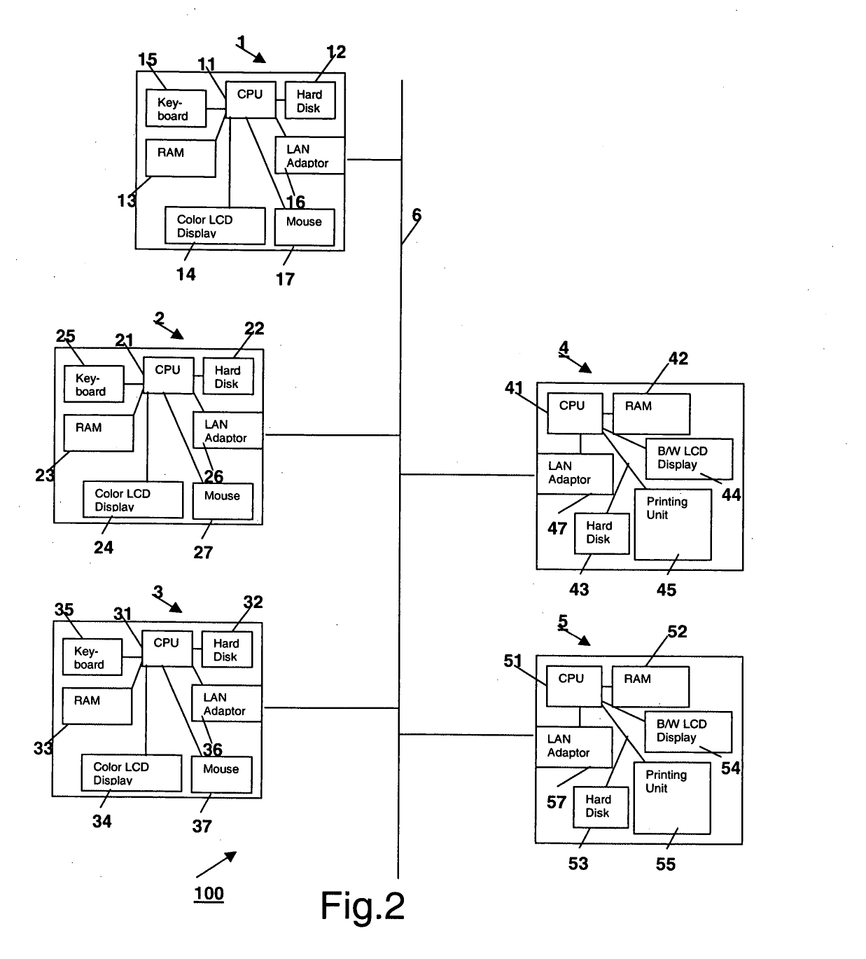

In certain embodiments, as illustrated in FIG. 2, the color and monochrome management printing system (e.g., a printing system 100) can comprise a management computer (e.g., a PC 1), two user computers (e.g., a PC 2 and a PC 3), two color printers (e.g., a high-end color laser beam printer (high-end color LBP) 4 and a low-end color laser beam printer (low-end color LBP) 5) and a LAN 6 connecting the PC 1, PC 2 and PC 3 with the high-end color LBP 4 and the low-end color LBP 5.

In certain embodiments, as illustrated in FIG. 2, the PC 1 as the management computer can comprise a reference information input section (e.g., a mouse 17 and a keyboard 15), a CPU 11, a hard disk 12, a RAM 13, a display section (e.g., a color LCD display) and a data transfer section (e.g., a LAN adaptor).

In certain embodiments, as illustrated in FIG. 2, the PC 2 as the user computer can comprise an input section (e.g., a keyboard 25 and a mouse 27), a data transfer section (e.g., a LAN adaptor 26), a CPU 21, a hard disk 22, a RAM 23, a display section (e.g., a color LCD display 24). In certain embodiments, OS and application software such as word processor software (e.g., Microsoft Word and the like) can be installed in the PC 2. In certain embodiments, the printer driver and the print spooler can be installed in the PC 2.

In certain embodiments, as illustrated in FIG. 2, the PC 3 as the user computer can comprise an input section (e.g., a keyboard 35 and a mouse 37), a data transfer section (e.g., a LAN adaptor 36), a CPU 31, a hard disk 32, a RAM 33, a display section (e.g., a color LCD display 34). In certain embodiments, OS and application software such as word processor software (e.g., Microsoft Word and the like) can be installed in the PC 3. In certain embodiments, the printer driver and the print spooler can be installed in the PC 3.

In certain embodiments, as illustrated in FIG. 2, the high-end color LBP 4 can comprise a storing section (e.g., a hard disk 43), an authorizing section (e.g., a CPU 41, a RAM 42 with necessary software stored in a hard disk 43), a print section (e.g., a printing unit 45) and a hard disk 43, a display section (e.g., a black white LCD display 44) and a data transfer section (e.g., a LAN adaptor 47). In certain embodiments, the software for the authorizing section can be installed in the high-end color LBP 4.

In certain embodiments, as illustrated in FIG. 2, the low-end color LBP 4 can comprise a storing section (e.g., a hard disk 53), an authorizing section (e.g., a CPU 51, a RAM 52 with necessary software stored in a hard disk 53), a print section (e.g., a printing unit 55) and a hard disk 53, a display section (e.g., a black white LCD display 54) and a data transfer section (e.g., a LAN adaptor 57). In certain embodiments, the software for the authorizing section can be installed in the low-end color LBP 5.

In this example, the color printer can comprise the print section, the authorizing section and the storing section and the user computer can comprise the input section and the management computer can comprise the reference information input section.

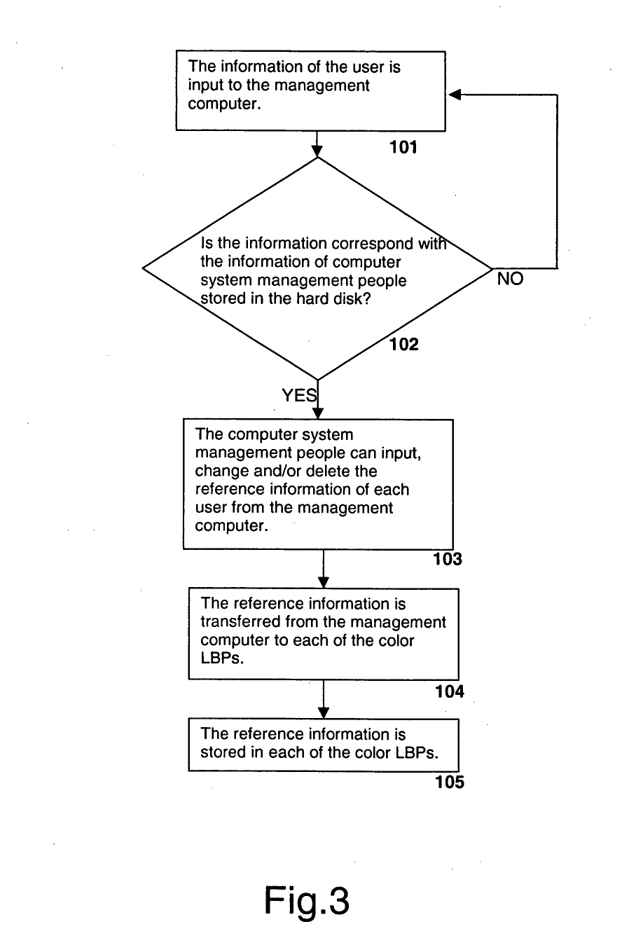

In certain embodiments, only limited people can use the PC 1 as the management computer. In certain embodiments, the hard disk 12 of the PC 1 can store the information of the computer system management people (e.g., user's name, ID number of the user, and/or the keyword for the user and the like) in advance. In certain embodiments, after turning on the PC 1, the user needs to input the information of the user (e.g., user's name, ID number of the user, and/or the keyword for the user and the like) from the keyboard 15 or the mouse 17 (101 in FIG. 3). Then, the PC 1 can judge whether the user is the computer system management people or not by comparing the information input from the keyboard 15 or the mouse 17 with the information stored in the hard disk 12 (102 in FIG. 3). If the PC 1 judges that the user is the computer system management people, the user can use the PC 1 and send and/or receive the information through the LAN 6. If the PC 1 judges that the user is not the computer system management people, the PC 1 does not start and the user cannot use the PC 1, or the PC 1 can start and the user can use the PC 1 but does not connect with the LAN 6 and the user cannot send and/or receive information through the LAN 6.

In certain embodiments, the computer system management people who can use the PC 1 as the management computer can input the reference information of each user comprising the authorized information and unauthorized information by the keyboard 15 or the mouse 17 as the reference information input section (103 in FIG. 3). For instance, the reference information used in this example can be described in the Table. 3. In certain embodiments, the computer system management people can change the reference information stored in the storing section by the reference information input section. In certain embodiments, the computer system management people can add new reference information by the reference information input section.

TABLE 3

| | | Color or | Type of | Color or | Type of |
|---|---|---|---|---|---|
| | | Monochrome | Reference | Monochrome | Reference |
| | Reference | print for LBP 4 | Information for | print for LBP 5 | Information for |
| User | Information | (high-end) | LBP 4 | (low-end) | LBP 5 |
| User A | ID number: | Color and | Authorized | Color and | Authorized |
| (Manager) | 12345 | Monochrome | Information | Monochrome | Information |
| | Keyword: | | | | |
| | XAFRDT | | | | |
| User B | ID number: | Only | Unauthorized | Color and | Authorized |
| (Secretary) | 12346 | Monochrome | Information | Monochrome | Information |
| | Keyword: | | | | |
| | FRHARK | | | | |
| User C | ID number: | Only | Unauthorized | Only | Unauthorized |
| (Regular | 12347 | Monochrome | Information | Monochrome | Information |
| Employee) | Keyword: | | | | |
| | KRMFDR | | | | |

In certain embodiments, the high-end color LBP 4 costs higher than the low-end color LBP 5 in respect of per one color print. Therefore, the number of people who can make color prints by the high-end color LBP 4 is limited more than the number of the people can make color prints by the low-end color LBP 5. In this embodiments, only the user A (manager) can make color prints by the high-end color LBP 4. On the other hand, the user A (manager) and the user B (secretary) can make color prints by the low-end color LBP 5. However, the user C (regular employee) can make only monochrome prints by the high-end color LBP 4 and the low-end color LBP 5.

In certain embodiments, the reference information input by the keyboard 15 or the mouse 16 as the reference information input section can be transferred from the PC 1 to the high-end color LBP 4 and the low-end color LBP 5 through the LAN adaptor 16, the LAN 6, the LAN adaptor 47 and the LAN adaptor 57 (104 in FIG. 3). In certain embodiments, the transferred reference information for the high-end color LBP 4 (e.g., the user A can make both of color prints and monochrome prints and the user B and the user C can make only monochrome prints by the high-end color LBP 4) can be stored in the hard disk 43 of the high-end color LBP 4 (105 in FIG. 3). In certain embodiments, the transferred reference information for the low-end color LBP 5 (e.g., the user A and the user B can make both of color prints and monochrome prints and the user C can make only monochrome prints by the low-end color LBP 5) can be stored in the hard disk 53 of the low-end color LBP 5 (105 in FIG. 3).

(The User A prints by High-End Color LBP 4)

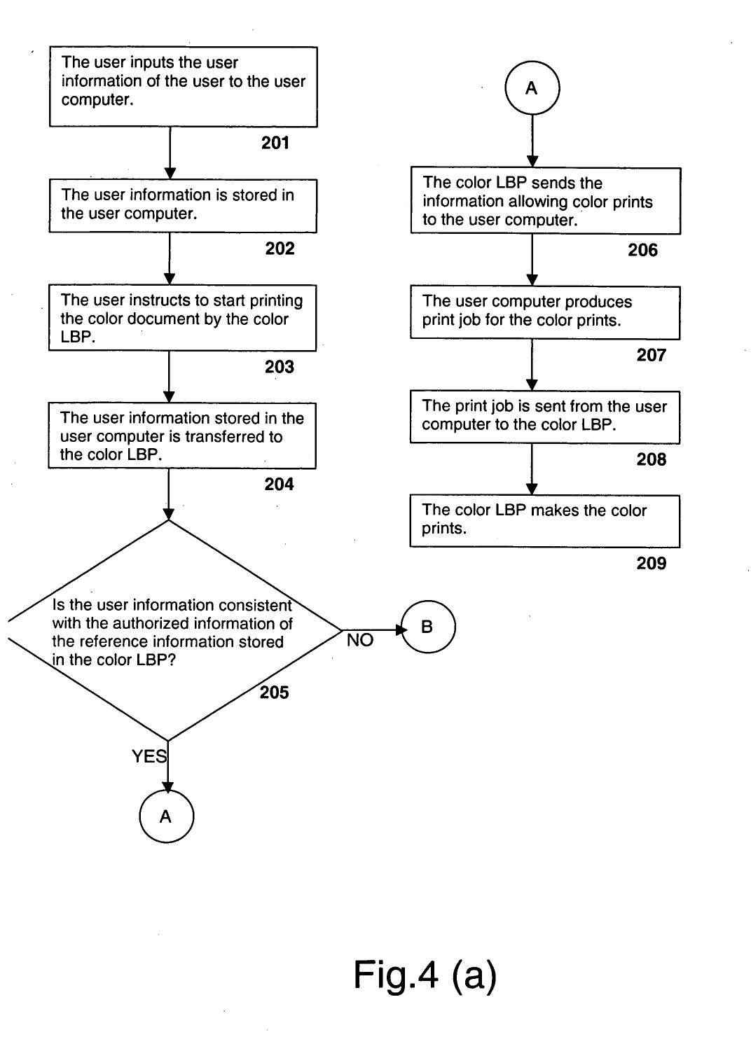

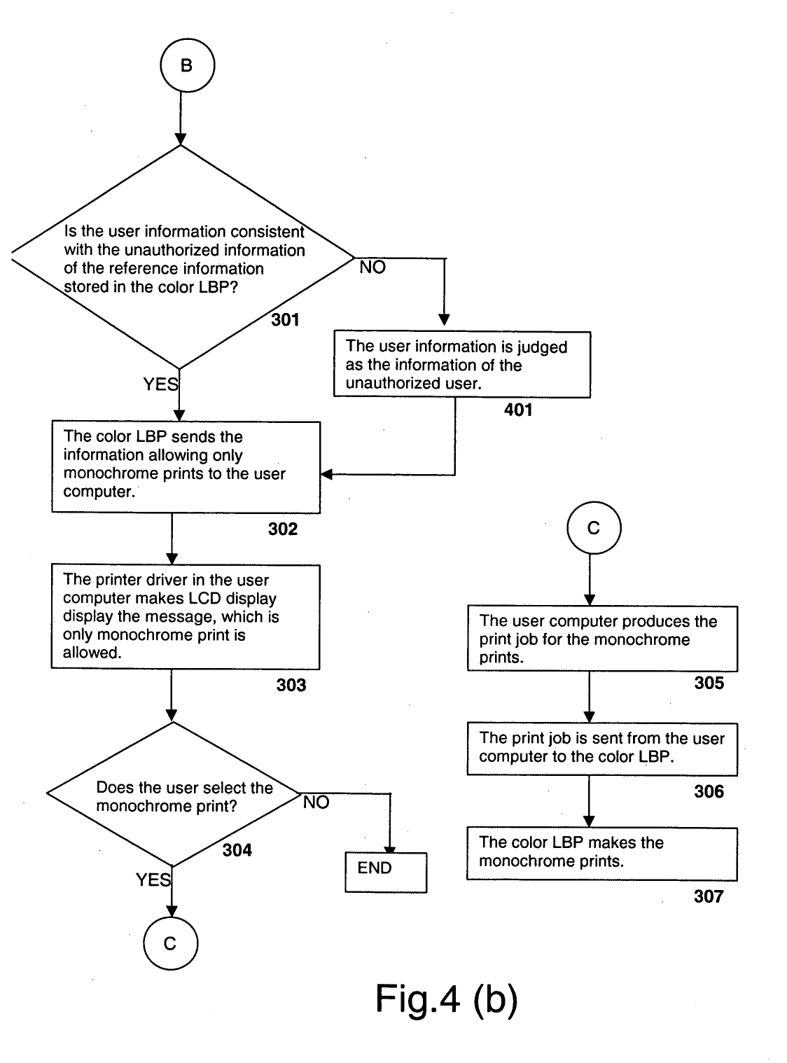

In certain embodiments, when the user A uses the PC 2 as the user computer, the user A can input the user information of the user A (e.g., ID number of the user A is 12345 and keyword of the user A is XAFRDT) (201 in FIG. 4) and the user information can be stored in the hard disk 22 of the PC 2 (202 in FIG. 4). In certain embodiments, the user A can produce color document data by utilizing the application software. In certain embodiments, when the user A instructs start printing the color document data by the high-end color LBP 4 (203 in FIG. 4), the user information of the user A stored in the hard disk 22 can be sent from the PC 2 to the high-end color LBP 4 through the LAN adaptor 26, the LAN 6 and the LAN adaptor 47 (204 in FIG. 4).

In certain embodiments, the user information of the user A received by the high-end color LBP 4 can be compared with the reference information of the user A stored in the hard disk 43 of the high-end color LBP 4 by the CPU 41 and the RAM 42 according to the software stored in the hard disk 43 as the authorizing section (205 in FIG. 4). In certain embodiments, the CPU 41 of the high-end color LBP 4 can detect that the user information of the user A is consistent with the authorized information of the reference information stored in the hard disk 43 and can judge the user information of the user A is the information of the authorized user for the high-end color LBP 4. The CPU 41 as the authorizing section can allow the user A to make color prints. In certain embodiments, the CPU 41 can send the instruction allowing color prints as the result of comparison to the PC 2 through the LAN adaptor 47, the LAN 6 and the LAN adaptor 26 by using a print job language (PJL) (206 in FIG. 4).

In certain embodiments, the CPU 21 of the PC 2 can receive the instruction allowing color prints for the user A from the high-end color LBP 4. Then, the CPU 21 can produce print job for color prints based on the color document data (207 in FIG. 4). In certain embodiments, the PC 2 can send the print job for the color prints to the high-end color LBP 4 through the LAN adaptor 26, the LAN 6 and the LAN adaptor 47 by using the PJL (208 in FIG. 4). In certain embodiments, the printing unit 45 of the high-end color LBP 4 can make color prints based on the received print job for the color prints (209 in FIG. 4).

(The User A prints by Low-End Color LBP 5)

In certain embodiments, when the user A instructs start printing the color document data by the low-end color LBP 5 (203 in FIG. 4), the user information of the user A stored in the hard disk 22 can be sent from the PC 2 to the low-end color LBP 5 through the LAN adaptor 26, the LAN 6 and the LAN adaptor 57 (204 in FIG. 4).

In certain embodiments, the user information of the user A received by the low-end color LBP 5 can be compared with the reference information of the user A stored in the hard disk 53 of the low-end color LBP 5 by the CPU 51 and the RAM 52 according to the software stored in the hard disk 53 as the authorizing section (205 in FIG. 4). In certain embodiments, the CPU 51 of the low-end color LBP 5 can detect that the user information of the user A is consistent with the authorized information of the reference information stored in the hard disk 53 and can judge the user information of the user A is the information of the authorized user for the low-end color LBP 5. The CPU 51 as the authorizing section can allow the user A to make color prints. In certain embodiments, the CPU 51 can send the instruction allowing color prints as the result of comparison to the PC 2 through the LAN adaptor 57, the LAN 6 and the LAN adaptor 26 by using a PJL (206 in FIG. 4).

In certain embodiments, the CPU 21 of the PC 2 can receive the instruction allowing color prints for the user A from the low-end color LBP 5. Then, the CPU 21 can produce print job for color prints based on the color document data (207 in FIG. 4). In certain embodiments, the PC 2 can send the print job for the color prints to the high-end color LBP 4 through the LAN adaptor 26, the LAN 6 and the LAN adaptor 57 by using the PJL (208 in FIG. 4). In certain embodiments, the printing unit 55 of the low-end color LBP 5 can make color prints based on the received print job for the color prints (209 in FIG. 4).

(The User B Prints by High-End Color LBP 4)

In certain embodiments, when the user B uses the PC 3 as the user computer, the user B can input the user information of the user B (e.g., ID number of the user B is 12346 and keyword of the user B is FRHARK) (201 in FIG. 4) and the user information can be stored in the hard disk 32 of the PC 3 (202 in FIG. 4). In certain embodiments, the user B can produce color document data by utilizing the application software. In certain embodiments, when the user B instructs start printing the color document data by the high-end color LBP 4 (203 in FIG. 4), the user information of the user B stored in the hard disk 32 can be sent from the PC 3 to the high-end color LBP 4 through the LAN adaptor 36, the LAN 6 and the LAN adaptor 47 (204 in FIG. 4).

In certain embodiments, the user information of the user B received by the high-end color LBP 4 can be compared with the reference information of the user B stored in the hard disk 43 of the high-end color LBP 4 by the CPU 41 and the RAM 42 according to the software stored in the hard disk 43 as the authorizing section (205, 301 in FIG. 4). In certain embodiments, the CPU 41 of the high-end color LBP 4 can detect that the user information of the user B is consistent with the unauthorized information of the reference information stored in the hard disk 43 and can judge the user information of the user B is the information of the unauthorized user for the high-end color LBP 4. The CPU 41 as the authorizing section might not allow the user B to make color prints, but can allow the user B to make only monochrome prints. In certain embodiments, the CPU 41 can send the instruction allowing only monochrome prints as the result of comparison to the PC 3 through the LAN adaptor 47, the LAN 6 and the LAN adaptor 36 by using a PJL (302 in FIG. 4).

In certain embodiments, the CPU 31 of the PC 3 can receive the instruction allowing only monochrome prints for the user B from the high-end color LBP 4. Then, according to the printer driver, the following message, “YOU ARE PROHIBITED FROM MAKING COLOR PRINT BY THIS PRINTER. DO YOU WANT TO MAKE MONOCHROME PRINT BY THIS PRINTER?”, and icons of “YES” and “NO” can be displayed on the color LCD display 34 (303 in FIG. 4). If the user B clicks the icon of “YES” on the color LDC display 34 by the mouse 37 (304 in FIG. 4), the CPU 31 can produce print job for monochrome prints based on the color document data produced by the user B (305 in FIG. 4). In certain embodiments, the PC 3 can send the print job for the monochrome prints to the high-end color LBP 4 through the LAN adaptor 36, the LAN 6 and the LAN adaptor 47 (306 in FIG. 4). In certain embodiments, the printing unit 45 of the high-end color LBP 4 can make monochrome prints based on the received print job for the monochrome prints (307 in FIG. 4).

(The User B Prints by Low-End Color LBP 5)

In certain embodiments, when the user B instructs start printing the color document data by the low-end color LBP 5 (203 in FIG. 4), the user information of the user B stored in the hard disk 32 can be sent from the PC 3 to the low-end color LBP 5 through the LAN adaptor 36, the LAN 6 and the LAN adaptor 57 (204 in FIG. 4).

In certain embodiments, the user information of the user B received by the low-end color LBP 5 can be compared with the reference information of the user B stored in the hard disk 53 of the low-end color LBP 5 by the CPU 51 and the RAM 52 according to the software stored in the hard disk 53 as the authorizing section. In certain embodiments, the CPU 51 of the low-end color LBP 5 can detect that the user information of the user B is consistent with the authorized information of the reference information stored in the hard disk 53 and can judge the user information of the user B is the information of the authorized user for the low-end color LBP 5 (205 in FIG. 4). The CPU 51 as the authorizing section can allow the user B to make color prints. In certain embodiments, the CPU 51 can send the instruction allowing color prints as the result of comparison to the PC 3 through the LAN adaptor 57, the LAN 6 and the LAN adaptor 36 by using a PJL (206 in FIG. 4).

In certain embodiments, the CPU 31 of the PC 3 can receive the instruction allowing color prints for the user B from the low-end color LBP 5. Then, the CPU 31 can produce print job for color prints based on the color document data produced by the user B (207 in FIG. 4). In certain embodiments, the PC 3 can send the print job for the color prints to the low-end color LBP 5 through the LAN adaptor 36, the LAN 6 and the LAN adaptor 57 by using the PJL(208 in FIG. 4). In certain embodiments, the printing unit 55 of the low-end color LBP 5 can make color prints based on the received print job for the color prints (209 in FIG. 4).

(The User C prints by the Low-End Color LBP 5)

In certain embodiments, when the user C uses the PC 3 as the user computer, the user C can input the user information of the user C (e.g., ID number of the user C is 12347 and keyword of the user C is KRMFDR) (201 in FIG. 4) and the user information can be stored in the hard disk 32 of the PC 3 (202 in FIG. 4). In certain embodiments, the user C can produce color document data by utilizing the application software. In certain embodiments, when the user C instructs start printing the color document data by the low-end color LBP 5 (203 in FIG. 4), the user information of the user C stored in the hard disk 32 can be sent from the PC 3 to the low-end color LBP 5 through the LAN adaptor 36, the LAN 6 and the LAN adaptor 57 (204 in FIG. 4).

In certain embodiments, the user information of the user C received by the low-end color LBP 5 can be compared with the reference information of the user C stored in the hard disk 53 of the low-end color LBP 5 by the CPU 51 and the RAM 52 according to the software stored in the hard disk 53 as the authorizing section (205, 301 in FIG. 4). In certain embodiments, the CPU 51 of the low-end color LBP 5 can detect that the user information of the user C is consistent with the unauthorized information of the reference information stored in the hard disk 53 and can judge the user information of the user C is the information of the unauthorized user for the low-end color LBP 5. The CPU 51 as the authorizing section might not allow the user C to make color prints, but can allow the user C to make only monochrome prints by the low-end color LBP 5. In certain embodiments, the CPU 51 can send the instruction allowing only monochrome prints as the result of comparison to the PC 3 through the LAN adaptor 57, the LAN 6 and the LAN adaptor 36 by using a PJL (302 in FIG. 4).

In certain embodiments, the CPU 31 of the PC 3 can receive the instruction allowing only monochrome prints for the user C from the low-end color LBP 5. Then, according to the printer driver, the following message, “YOU ARE PROHIBITED FROM MAKING COLOR PRINT BY THIS PRINTER. DO YOU WANT TO MAKE MONOCHROME PRINT BY THIS PRINTER?”, and icons of “YES” and “NO” can be displayed on the color LCD display 34 (303 in FIG. 4). If the user C clicks the icon of “YES” on the color LDC display 34 by the mouse 37 (304 in FIG. 4), the CPU 31 can produce print job for monochrome prints based on the color document data produced by the user C (305 in FIG. 4). In certain embodiments, the PC 3 can send the print job for the monochrome prints to the low-end color LBP 5 through the LAN adaptor 36, the LAN 6 and the LAN adaptor 57 by using the PJL. In certain embodiments, the printing unit 55 of the low-end color LBP 5 can make monochrome prints based on the received print job for the monochrome prints (307 in FIG. 4).

(The User D Prints by the Low-End Color LBP 5)

In certain embodiments, when the user D uses the PC 3 as the user computer, the user D can input the user information of the user D (e.g., ID number of the user D is 12348 and keyword of the user D is IRKDRA) (201 in FIG. 4) and the user information can be stored in the hard disk 32 of the PC 3 (202 in FIG. 4). In certain embodiments, the user D can produce color document data by utilizing the application software. In certain embodiments, when the user D instructs start printing the color document data by the low-end color LBP 5 (203 in FIG. 4), the user information of the user D stored in the hard disk 32 can be sent from the PC 3 to the low-end color LBP 5 through the LAN adaptor 36, the LAN 6 and the LAN adaptor 57 (204 in FIG. 4).

In certain embodiments, the user information of the user D received by the low-end color LBP 5 can be compared with the reference information stored in the hard disk 53 of the low-end color LBP 5 by the CPU 51 and the RAM 52 according to the software stored in the hard disk 53 as the authorizing section. However, the reference information of the user D is not stored in the hard disk 53. Therefore, in certain embodiments, the CPU 51 of the low-end color LBP 5 can detect that the user information of the user D is not consistent with any of the authorized information and the unauthorized information of the reference information stored in the hard disk 53 (205, 301 in FIG. 4) and can judge the user information of the user D is the information of the unauthorized user for the low-end color LBP 5 (401 in FIG. 4). The CPU 51 as the authorizing section might not allow the user D to make color prints, but can allow the user D to make only monochrome prints by the low-end color LBP 5. In certain embodiments, the CPU 51 can send the instruction allowing only monochrome prints as the result of comparison to the PC 3 through the LAN adaptor 57, the LAN 6 and the LAN adaptor 36 by using a PJL (302 in FIG. 4).

In certain embodiments, the CPU 31 of the PC 3 can receive the instruction allowing only monochrome prints for the user D from the low-end color LBP 5. Then, according to the printer driver, the following message, “YOU ARE PROHIBITED FROM MAKING COLOR PRINT BY THIS PRINTER. DO YOU WANT TO MAKE MONOCHROME PRINT BY THIS PRINTER?”, and icons of “YES” and “NO” can be displayed on the color LCD display 34 (303 in FIG. 4). If the user D clicks the icon of “YES” on the color LDC display 34 by the mouse 37 (304 in FIG. 4), the CPU 31 can produce print job for monochrome prints based on the color document data produced by the user D (305 in FIG. 4). In certain embodiments, the PC 3 can send the print job for the monochrome prints to the low-end color LBP 5 through the LAN adaptor 36, the LAN 6 and the LAN adaptor 57 by using the PJL (306 in FIG. 4). In certain embodiments, the printing unit 55 of the low-end color LBP 5 can make monochrome prints based on the received print job for the monochrome prints (307 in FIG. 4).

### EXAMPLE 2

In certain embodiments, as illustrated in FIG. 2, the color and monochrome management printing system (e.g., a printing system 100) can comprise a management computer (e.g., a PC 1), two user computers (e.g., a PC 2 and a PC 3), two color printers (e.g., a high-end color laser beam printer (high-end color LBP) 4 and a low-end color laser beam printer (low-end color LBP) 5) and a LAN 6 connecting the PC 1, PC 2 and PC 3 with the high-end color LBP 4 and the low-end color LBP 5.

In certain embodiments, as illustrated in FIG. 2, the PC 1 as the management computer can comprise a reference information input section (e.g., a mouse 17 and a keyboard 15), a CPU 11, a hard disk 12, a RAM 13, a display section (e.g., a color LCD display) and a data transfer section (e.g., a LAN adaptor).

In certain embodiments, as illustrated in FIG. 2, the PC 2 as the user computer can comprise a storing section (e.g., a hard disk 22), an input section (e.g., a keyboard 25, a mouse 27, a CPU 21 and a RAM 23 with necessary software stored in the hard disk 22), an authorizing section (e.g., a CPU 21 and a RAM 23 with necessary software stored in the hard disk 22), a data transfer section (e.g., a LAN adaptor 26) and a display section (e.g., a color LCD display 24). In certain embodiments, OS and application software such as word processor software (e.g., Microsoft Word and the like) can be installed in the PC 2. In certain embodiments, the printer driver and the print spooler can be installed in the PC 2. In certain embodiments, the software for the input section and the authorizing section can be installed in the PC 2.

In certain embodiments, as illustrated in FIG. 2, the PC 3 as the user computer can comprise a storing section (e.g., a hard disk 32), an input section (e.g., a keyboard 35, a mouse 37, a CPU 31 and a RAM 33 with necessary software stored in the hard disk 32), an authorizing section (e.g., a CPU 31 and a RAM 33 with necessary software stored in the hard disk 32), a data transfer section (e.g., a LAN adaptor 36) and a display section (e.g., a color LCD display 34). In certain embodiments, OS and application software such as word processor software (e.g., Microsoft Word and the like) can be installed in the PC 3. In certain embodiments, the printer driver and the print spooler can be installed in the PC 3. In certain embodiments, the software for the input section and the authorizing section can be installed in the PC 3.

In certain embodiments, as illustrated in FIG. 2, the high-end color LBP 4 can comprise a hard disk 43, a CPU 41, a RAM 42, a print section (e.g., a printing unit 45), a display section (e.g., a black white LCD display 44) and a data transfer section (e.g., a LAN adaptor 47).

In certain embodiments, as illustrated in FIG. 2, the high-end color LBP 5 can comprise a hard disk 53, a CPU 51, a RAM 52, a print section (e.g., a printing unit 55), a display section (e.g., a black white LCD display 54) and a data transfer section (e.g., a LAN adaptor 57).

In this example, the user computer can comprise the input section, the authorizing section and the storing section and the color printer can comprise the print section and the management computer can comprise the reference information input section.

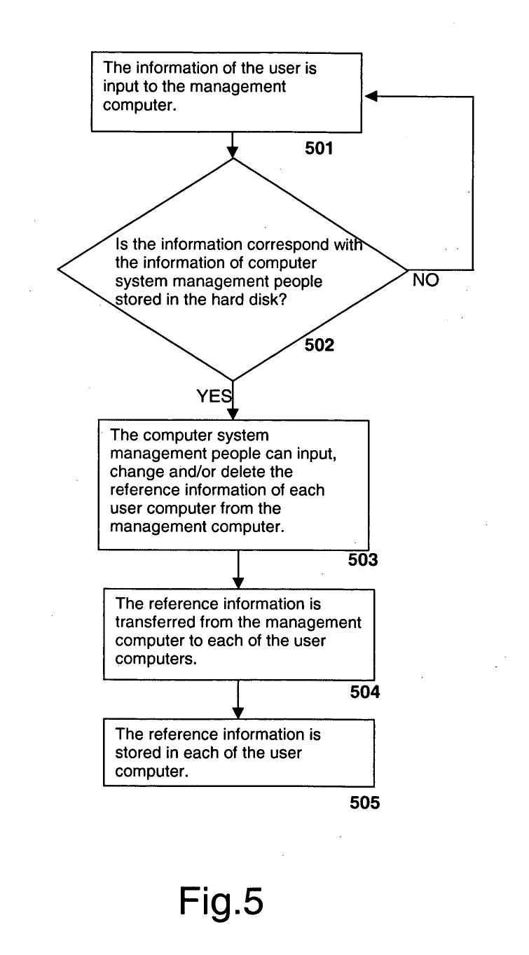

In certain embodiments, only limited people can use the PC 1 as the management computer. In certain embodiments, the hard disk 12 of the PC 1 can store the information of the computer system management people (e.g., user's name, ID number of the user, and/or the keyword for the user and the like) in advance. In certain embodiments, after turning on the PC 1, the user needs to input the information of the user (e.g., user's name, ID number of the user, and/or the keyword for the user and the like) from the keyboard 15 or the mouse 17 (501 in FIG. 5). Then, the PC 1 can judge whether the user is the computer system management people or not by comparing the information input from the keyboard 15 or the mouse 17 with the information stored in the hard disk 12 (502 in FIG. 5). If the PC 1 judges that the user is the computer system management people, the user can use the PC 1 and send and/or receive the information through the LAN 6. If the PC 1 judges that the user is not the computer system management people, the PC 1 does not start and the user cannot use the PC 1, or the PC 1 can start and the user can use the PC 1 but does not connect with the LAN 6 and the user cannot send and/or receive information through the LAN 6.

In certain embodiments, the computer system management people who can use the PC 1 as the management computer can input the reference information of each user computer comprising the authorized information and unauthorized information by the keyboard 15 or the mouse 17 as the reference information input section (503 in FIG. 5). For instance, the reference information used in this example can be described in the Table. 4. In certain embodiments, the computer system management people can change the reference information stored in the storing section by the reference information input section. In certain embodiments, the computer system management people can add new reference information by the reference information input section.

TABLE 4

| | | Color or | Type of | Color or | Type of |
|---|---|---|---|---|---|
| | | Monochrome | Reference | Monochrome | Reference |
| | Reference | print for LBP 4 | Information for | print for LBP 5 | Information for |
| User | Information | (high-end) | LBP 4 | (low-end) | LBP 5 |
| PC 2 | Name of the | Color and | Authorized | Color and | Authorized |
| (The user | user computer: | Monochrome | Information | Monochrome | Information |
| computer for | 001 | | | | |
| Manager) | | | | | |
| PC 3 | Name of the | Only | Unauthorized | Color and | Authorized |
| (The user | user computer: | Monochrome | Information | Monochrome | Information |
| computer for | 002 | | | | |
| Regular | | | | | |
| Employee) | | | | | |

In certain embodiments, the high-end color LBP 4 costs higher than the low-end color LBP 5 in respect of per one color print. Therefore, the number of people who can make color prints by the high-end color LBP 4 is limited more than the number of the people who can make color prints by the low-end color LBP 5. In this embodiments, only the manager who uses the PC 2 can make both of color prints and monochrome prints by the high-end color LBP 4 and the low-end color LBP 5. On the other hand, the regular employee who uses the PC 3 can make both of color prints and monochrome prints by the low-end color LBP 5, but can make only monochrome prints by the high-end color LBP 4.

In certain embodiments, the reference information input by the keyboard 15 or the mouse 16 as the reference information input section can be transferred from the PC 1 to the PC 2 and the PC 3 through the LAN adaptor 16, the LAN 6, the LAN adaptor 26 and the LAN adaptor 36 (504 in FIG. 5). In certain embodiments, the hard disk 22 as the storing section can store the transferred reference information for both of the PC 2 and the PC 3 (e.g., the PC 2 can instruct to make color prints by both of the high-end color LBP 4 and the low-end color LBP 5, and the PC 3 can instruct to make color prints by the low-end color LBP 5 and to make only monochrome prints by the high-end color LBP 5) (505 in FIG. 5). In certain embodiments, the hard disk 32 as the storing section can store the transferred reference information for both of the PC 2 and the PC 3 (e.g., the PC 2 can instruct to make color prints by both of the high-end color LBP 4 and the low-end color LBP 5, and the PC 3 can instruct to make color prints by the low-end color LBP 5 and to make only monochrome prints by the high-end color LBP 5) (505 in FIG. 5).

(The User A Prints by the High-End Color LBP 4)

In certain embodiments, when the user A who is a manager uses the PC 2 as the user computer, the user A can input the information of the user A (e.g., ID number of the user A is 12345 and keyword of the user A is XAFRDT) and the PC 2 can judge whether the user is the user who can use the PC 2 or not based on the information recorded in the hard disk 22 in advance.

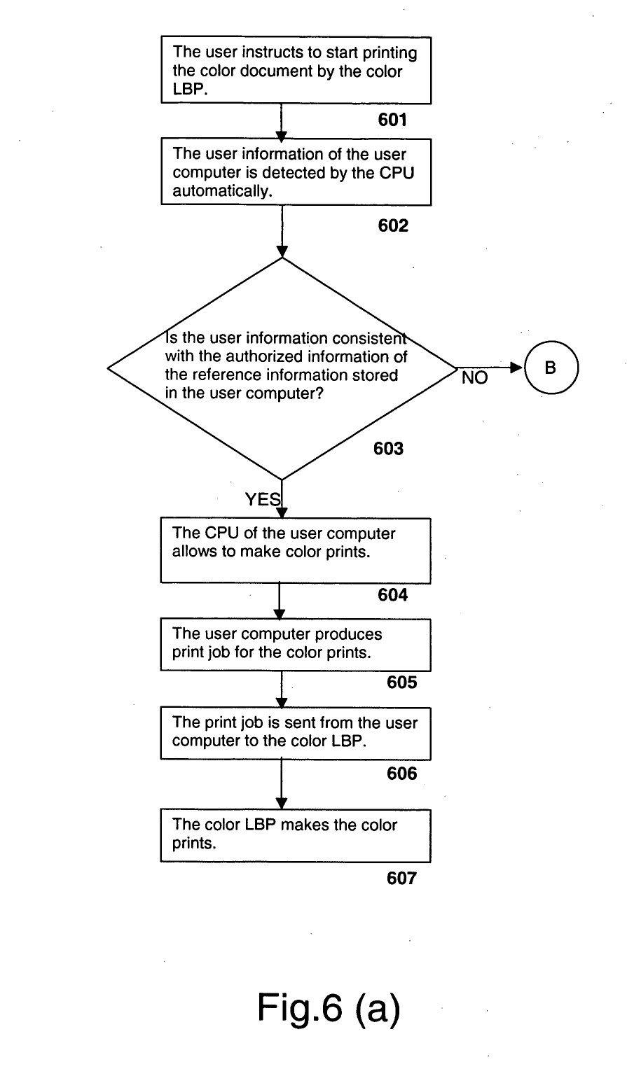

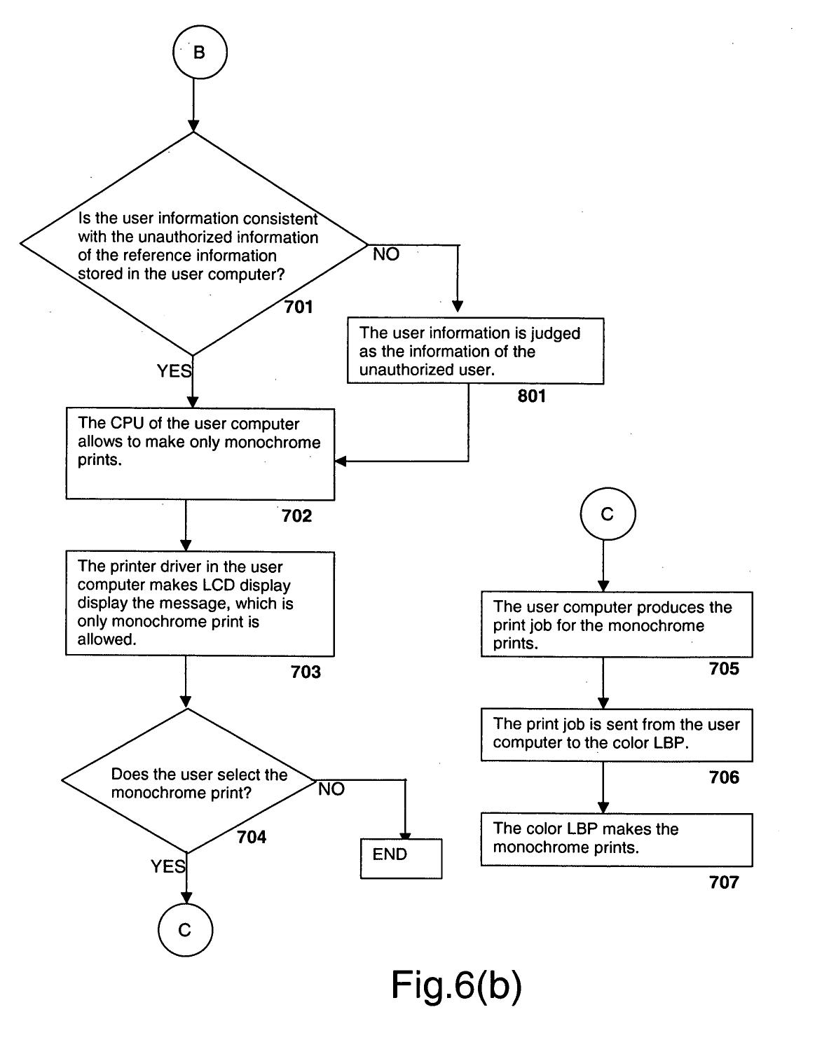

In certain embodiments, if the PC 2 judges that the user A is the authorized user who can use the PC 2, the user A can produce color document data by utilizing the application software. In certain embodiments, when the user A instructs start printing the color document data by the high-end color LBP 4 (601 in FIG. 6), the CPU 21 as the input section according to software (such as API or operating system (OS)) which is the software for input section can detect and obtain the user information of the PC 2 (e.g., 001, which is the name of the PC 2) automatically and the CPU 21 as the authorizing section can compare the user information of the PC 2 with the reference information (e.g., 001, which is the name of the user computer) stored in the hard disk 22 according to the printer driver which is the software for the authorizing section (603 in FIG. 6). If the CPU 21 detects that the user information of the PC 2 is consistent with the authorized information of the reference information stored in the hard disk 22, the CPU 21 can judge the user information of the PC 2 is the information of the authorized user for the high-end color LBP 4. The CPU 21 as the authorizing section can allow the user A to make color prints by allowing the PC 2 to instruct color prints (604 in FIG. 6). Then, the CPU 21 can produce a print job for color prints based on the color document data (605 in FIG. 6). In certain embodiments, the PC 2 can send the print job for the color prints to the high-end color LBP 4 through the LAN adaptor 26, the LAN 6 and the LAN adaptor 47 by using the PJL (606 in FIG. 6). In certain embodiments, the printing unit 45 of the high-end color LBP 4 can make color prints based on the received print job for the color prints (607 in FIG. 6).

(The User B Prints by the High-End Color LBP 4)

In certain embodiments, when the user B who is a regular employee uses the PC 3 as the user computer, the user B can input the information of the user B (e.g., ID number of the user B is 12346 and keyword of the user A is FRHARK) and the PC 3 can judge whether the user is the user who can use the PC 3 or not based on the information recorded in the hard disk 32 in advance.

In certain embodiments, if the PC 3 judges that the user B is the authorized user who can use the PC 3, the user B can produce color document data by utilizing the application software. In certain embodiments, when the user B instructs start printing the color document data by the high-end color LBP 4 (601 in FIG. 6), the CPU 31 as the input section according to the software (e.g., API or OS) which is the software for the input section can detect and obtain the user information of the PC 3 (e.g., 002, which is the name of the PC 3) automatically and the CPU 31 as the authorizing section can compare the user information of the PC 3 with the reference information (e.g., 002, which is the name of the user computer) stored in the hard disk 32 according to the printer driver which is the software for the authorizing section (603, 701 in FIG. 6). If the CPU 31 detects that the user information of the PC 3 is consistent with the unauthorized information of the reference information stored in the hard disk 32 (701 in FIG. 6), the CPU 31 can judge the user information of the PC 3 is the information of the unauthorized user for the high-end color LBP 4. The CPU 31 as the authorizing section can allow the user B to make only monochrome prints by prohibiting the PC 3 from accepting the instruction of color prints (702 in FIG. 6). Then, according to the printer driver, the following message, “YOU ARE PROHIBITED FROM MAKING COLOR PRINT BY THIS PRINTER. DO YOU WANT TO MAKE MONOCHROME PRINT BY THIS PRINTER?”, and icons of “YES” and “NO” can be displayed on the color LCD display 34 (703 in FIG. 6). If the user B clicks the icon of “YES” on the color LDC display 34 by the mouse 37 (704 in FIG. 6), the CPU 31 can produce print job for monochrome prints based on the color document data produced by the user B (705 in FIG. 6).

In certain embodiments, the PC 3 can send the print job for the monochrome prints to the high-end color LBP 4 through the LAN adaptor 36, the LAN 6 and the LAN adaptor 47 by using the PJL (706 in FIG. 6). In certain embodiments, the printing unit 45 of the high-end color LBP 4 can make monochrome prints based on the received print job for the monochrome prints (707 in FIG. 6).

(The User B prints by the Low-End Color LBP 5)

In certain embodiments, when the user B instructs start printing the color document data by the low-end color LBP 5 (601 in FIG. 6), the CPU 31 as the input section according to the software (e.g., the API or the OS) which is also the software for input section can detect and obtain the user information of the PC 3 (e.g., 002, which is the name of the PC 3) automatically and the CPU 31 as the authorizing section can compare the user information of the PC 3 with the reference information (e.g., 002, which is the name of the user computer) stored in the hard disk 32 according to the print driver which is the software for the authorizing section (603 in FIG. 6). If the CPU 31 detects that the user information of the PC 3 is consistent with the authorized information of the reference information stored in the hard disk 32, the CPU 31 can judge the user information of the PC 3 is the information of the authorized user for the low-end color LBP 5. The CPU 31 as the authorizing section can allow the user B to make color prints by allowing the PC 3 to instruct color prints (604 in FIG. 6). Then, the CPU 31 can produce print job for color prints based on the color document data (605 in FIG. 6). In certain embodiments, the PC 3 can send the print job for the color prints to the low-end color LBP 5 through the LAN adaptor 36, the LAN 6 and the LAN adaptor 57 by using the PJL (606 in FIG. 6). In certain embodiments, the printing unit 55 of the low-end color LBP 5 can make color prints based on the received print job for the color prints (607 in FIG. 6).

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A color and monochrome management printing system, comprising:
a storing section that stores reference information,
an input section that inputs user information,
an authorizing section that compares the user information input by the input section with the reference information stored in the storing section,
a print section that makes a color print and a monochrome print,
wherein if the authorizing section judges that the user information is the information of the authorized user as a result of comparing the user information with the reference information, the authorizing section allows the print section to make both of the color print and the monochrome print, and
wherein if the authorizing section judges that the user information is the information of the unauthorized user as a result of comparing the user information with the reference information, the authorizing section allows the print section to make only the monochrome print, but not the color print.

2. The color and monochrome management printing system of claim 1, wherein the reference information comprises authorized information, and
wherein if the authorizing section detects that the user information input by the input section is consistent with the authorized information stored in the storing section, the authorizing section judges that the user information is the information of the authorized user.

3. The color and monochrome management printing system of claim 2, wherein if authorizing section detects that there is no authorized information which is consistent with the user information input by the input section in the storing section, the authorizing section judges that the user information is the information of the unauthorized user.

4. The color and monochrome management printing system of claim 2, wherein the reference information comprises unauthorized information in addition to the authorized information, and
wherein if the authorizing section detects that the user information input by the input section is consistent with the unauthorized information stored in the storing section, the authorizing section judges that the user information is the information of the unauthorized user.

5. The color and monochrome management printing system of claim 4, wherein if the authorizing section detects that there is no authorized information which is consistent with the user information input by the input section and there is no unauthorized information which is consistent with the user information input by the input section, the authorizing section judges that the user information is the information of the unauthorized user.

6. The color and monochrome management printing system of claim 1, wherein the color and monochrome management printing system comprises an user computer and a color printer, and
wherein the user computer comprises the input section, and
wherein the color printer comprises the storing section, the authorizing section and the print section.

7. The color and monochrome management printing system of claim 6, wherein the color and monochrome management printing system comprises a management computer comprising a reference information input section, and
wherein the reference information input by the reference information input section is stored in the storing section.

8. The color and monochrome management printing system of claim 1, wherein the color and monochrome management printing system comprises an user computer and a color printer, and
wherein the user computer comprises the input section, the storing section and the authorizing section and
wherein the color printer comprises the print section.

9. The color and monochrome management printing system of claim 8, wherein the color and monochrome management printing system comprises a management computer comprising a reference information input section, and
wherein the reference information input by the reference information input section is stored in the storing section.

10. The color and monochrome management printing system of claim 1, wherein the authorizing section allows directly the print section to make both of the color print and the monochrome print, and
wherein the authorizing section allows directly the print section to make only the monochrome print, but not the color print.

11. The color and monochrome management printing system of claim 1, wherein the color and monochrome management printing system comprises an user computer comprising a printer driver, and
wherein the authorizing section allows the print section to make both of the color print and the monochrome print by allowing the printer driver to make both of the color print and the monochrome print,
wherein the authorizing section allows the print section to make only the monochrome print by allowing the printer driver to make only the monochrome print.
